(19) United States
(12) Patent Application Publication
(10) Pub. No.: US 2026/0030592 A1
(43) Pub. Date: Jan. 29, 2026

(54) COMPUTER-IMPLEMENTED METHOD FOR PROVIDING ACCESS TO CONSTRUCTION DATA OF A PRODUCT OF A PROVIDER TO A SUPPLIER FOR THIS PRODUCT OR FOR COMPONENTS OF THIS PRODUCT

(71) Applicant: material.one AG, Augsburg (DE)

(72) Inventor: Christian Buss, Augsburg (DE)

(21) Appl. No.: 19/253,787

(22) Filed: Jun. 28, 2025

(30) Foreign Application Priority Data
Jul. 29, 2024 (EP) 24191463

(51) Int. Cl. G06Q 10/0875; G06Q 50/04

(52) U.S. Cl. CPC G06Q 10/0875; G06Q 50/04

(57) ABSTRACT

In the computer-implemented method for mediating access to construction data of a product and/or its parts and/or components of a product provider to a potential supplier manufacturing or procuring the product for the product provider, construction data is separated into structural data on the one hand and sensitive geometric data on the other. A supplier requires both data sets for further processing. The supplier can display the structural data via an Internet platform of an intermediary. If the supplier then wants to obtain knowledge of the geometry data, this geometry data is released through the intermediary, which does not have the geometry data at any time and does not receive it from the product provider or even from the supplier. The intermediary typically provides the product provider with a software component that enables process steps for the supplier to access the geometry data (in encrypted form) of the product provider.

### CROSS REFERENCE TO RELATED APPLICATIONS

The present patent application is a US Non-Provisional Patent Application claiming priority to and the benefit of German patent application DE 10 2024 118 537.6 and European patent application EP 24 191 463.9, the disclosures of each of which are incorporated in the present patent application by reference.

### TECHNICAL FIELD

The disclosure relates to a computer-implemented method for automatically providing access to construction data of a product and/or its parts and/or components of a provider to a potential supplier manufacturing or procuring the product for the provider for the purpose of transmitting the construction data via a data link from a computer system of the provider to a computer system of the supplier.

### BACKGROUND

Product providers in manufacturing supply chains share structural design data with potential suppliers for accurate quoting while protecting sensitive details. Existing platforms either expose full geometry to intermediaries or rely on cumbersome manual controls, creating security and efficiency trade-offs.

From WO-A-2021/078139 a blockchain based hybrid system and method thereof for construction document management is known.

U.S. Pat. No. 11,347,880 describes applying an authorization policy across multiple application programs with requests submitted through an HTTP-based API.

Moreover, US-A-2024/0086561 discloses a system and method for data management and security for digital manufacturing.

Finally, US-A-2002/0035450 describes a network-based system for the manufacture of parts with a virtual collaborative environment for design, development, and fabricator selection.

### BRIEF DESCRIPTION OF THE DRAWINGS

FIG. 1 is an exemplary block diagram illustrating a process for controlling access to data between a provider and one or more suppliers.

### DESCRIPTION

Disclosed herein is a computer-implemented method for automatically providing access to construction data of a product of a provider and/or of parts and/or components of a product of a provider to a potential supplier manufacturing or procuring the product for the provider for the purpose of transmitting the construction data via a data link between a computer system of the provider and a computer system of the supplier. The construction data in the computer system of the provider is divided into at least two sets of data, namely structural data representative of, inter alia, the general structure of the product and/or of at least one of its parts and/or of at least one of its components and, if applicable, at least one of its sub-components, and geometry data representative of, inter alia, the geometric arrangement and geometry and dimensions of the product and/or of at least one of its parts and/or of at least one of its components and/or, if applicable, at least one of its sub-components, with knowledge of the at least two sets of data being required for the manufacture and/or for the procurement of the product and/or of at least one of its parts and/or of at least one of its components and/or, if applicable, at least one of its sub-components. A platform is provided on the Internet by a computer system of an intermediary, via which a supplier previously registered on the platform can download the structural data using its computer system. The geometry data is only available via the computer system of the provider and the transmission of the geometry data to the computer system of the supplier is exclusively enabled via the computer system of the provider. The computer system of the intermediary upon a request from the computer system of the supplier via the Internet and requests access to the geometry data from the computer system of the provider for the supplier via the Internet by transmitting the geometry data from the computer system of the provider to the computer system of the supplier. The computer system of the provider generates an access code for access to the geometry data by the computer system of the supplier and transmits this access code to the computer system of the intermediary via the Internet. The computer system of the intermediary forwards the access code to the computer system of the supplier via the Internet, and by the computer system of the supplier, using the access code from the computer system of the provider, the geometry data of the product and/or of at least one of its parts and/or of at least one of its components or, if applicable, of at least one of its sub-components can be retrieved and/or downloaded via the data link between the computer system of the provider and the computer system of the supplier.

In another example, the supplier registered in the computer system of the intermediary may have been previously authorized by the computer system of the provider vis-à-vis the computer system of the intermediary.

In another example, the retrievability of the geometry data from the computer system of the provider by the computer system of the supplier may be limited in time after receipt of the access code.

In another example, a graphical representation of the product and/or of at least one of its parts and/or of at least one of its components and possibly of at least one of its sub-components may be available to the supplier by downloading the structural data from the internet platform of the intermediary.

In another example, the Internet may be used for the data link between the computer system of the provider and the computer system of the supplier.

The geometry data may be transmitted in encrypted form via the data link between the computer system of the provider and the computer system of the supplier.

The provider may be a car manufacturer and the supplier may be a first tier for a part or a component of the car of the car manufacturer or a first tier for a car manufacturer with the supplier being a supplier for the first tier.

One or more computers may be programmed to execute any of the steps disclosed herein.

As part of the sampling of components, a graphic representation of the component or of components, parts or, if applicable, sub-components of the product is to be presented to the potential supplier for a product of a provider on an internet platform of an intermediary. This representation provides a better overview of the component structure of the product and also helps to navigate between the parts, components, and sub-components. However, no geometric data of the product or of parts, components or sub-components of the product should be presented at this stage.

It is an object of the disclosure to ensure that a potential supplier is enabled to access the data of the construction of a product to be marketed by a provider while maintaining the confidentiality of parts of the data, namely the geometry data.

To achieve this object, the disclosure relates to a computer-implemented method for automatically providing access to construction data of a product of a provider and/or of parts and/or components of a product of a provider to a potential supplier manufacturing or procuring the product for the provider for the purpose of transmitting the construction data via a data link between a computer system of the provider and a computer system of the supplier, wherein in the method
the construction data in the provider's computer system is divided into at least two sets of data, namely structural data representative of, inter alia, the general structure of the product and/or of at least one of its parts and/or of at least one of its components and, if applicable, at least one of its sub-components, and geometry data representative of, inter alia, the geometric arrangement and geometry and dimensions of the product and/or of at least one of its parts and/or of at least one of its components and/or, if applicable, at least one of its sub-components, knowledge of the at least two sets of data needed for the manufacture and/or for the procurement of the product and/or of at least one of its parts and/or of at least one of its components and/or, if applicable, at least one of its sub-components,
a platform is provided on the Internet by a computer system of an intermediary, via which a supplier previously registered on the platform can download the structural data using his computer system,
the geometry data is only available via the provider's computer system and the transmission of the geometry data to the supplier's computer system is enabled via the provider's computer system,
the intermediary's computer system responds to a request from the supplier's computer system via the Internet and requests access to the geometry data from the provider's computer system for the supplier via the Internet by transmitting the geometry data from the supplier's computer system,
the provider's computer system generates an access code for access to the geometry data by the supplier's computer system and transmits this access code to the intermediary's computer system via the Internet,
the intermediary's computer system forwards the access code to the supplier's computer system via the Internet, and
by the supplier's computer system, using the access code from the provider's computer system, the geometry data of the product and/or of at least one of its parts and/or of at least one of its components or, if applicable, of at least one of its sub-components can be retrieved and/or downloaded via the data link between the provider's computer system and the supplier's computer system.

The method according to the disclosure maximizes the protection of the geometry data, which is highly confidential and the release of which is the sole responsibility of the product provider. It is not possible to process this geometry data within the computer or computer system of the operator of the Internet platform (intermediary). Rather, the supplier can only retrieve the geometry data (directly) from the data owner, i.e. the product provider, i.e. download it in encrypted form via a protected data link or a public data link in order to integrate this data as a graphic into his computer system, for example.

First and foremost, the supplier initially only receives a so-called structure tree from the intermediary's Internet platform, which the supplier can convert into a graphic, depending on the software and provision by the intermediary (operator of the Internet platform).

It is advantageous if the supplier registered with the intermediary has previously been authorized by the provider vis-à-vis the intermediary.

In this case, the supplier may have the option, for a limited period of time, using the access code, to obtain from the provider the geometry data of the product or of at least one of its components and/or of at least one of its components of the product or a sub-component, also for a limited period of time if necessary.

Finally, it is preferably possible that a graphical representation of the product and/or of at least one of its parts and/or of at least one of its components and possibly of at least one of its sub-components is available to the supplier by downloading the structural data from the internet platform of the intermediary.

It is also useful if an encrypted communication channel (e.g., TLS) is used to send the access code from the provider's computer system to the intermediary's computer system and from there to the supplier's computer system. However, if E2E encryption is used, the data set received via the access code is encrypted.

It is also advisable for the geometry data to be transmitted in encrypted form via the data link between the provider's computer system and the supplier's computer system. The data link between the provider's computer system and the supplier's computer system is, for example, the Internet.

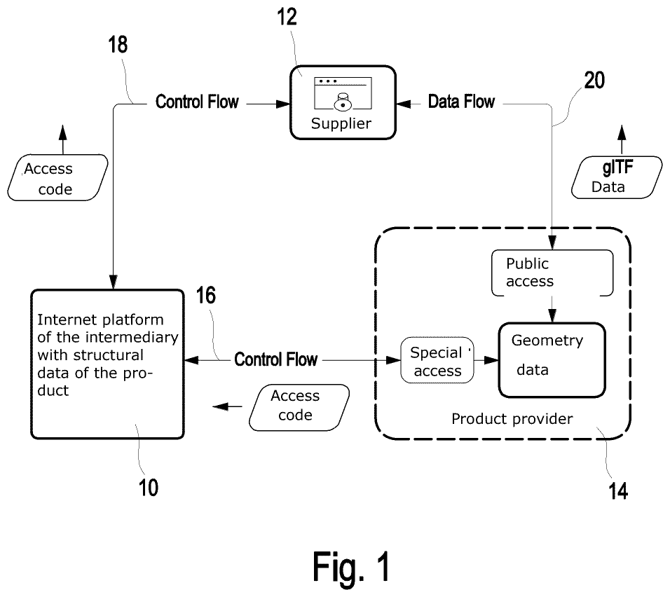

The disclosure is explained in more detail below with reference to an exemplary implementation in FIG. 1, which shows the method according to the disclosure as a block diagram. When reference is made hereinafter to the product provider, the supplier and the intermediary, this means their computer systems networked via the Internet, for example.

The operator of the Internet platform provides the provider of the product (data owner) with system components for the operation of an integration solution for geometry data. This application is operated under the sovereignty of the product provider and integrated into its system landscape and allows a supplier to obtain knowledge of construction data of a product or of parts, components or sub-components of the product through and from the product provider.

The Internet platform therefore acts as an intermediary between the supplier and the product provider for supplier requests for geometry data. For this purpose, the intermediary forwards supplier requests for authorization to the product provider via a privileged channel. After successful authorization, the supplier receives protected Internet addresses and uses these to retrieve the geometry data from the product provider via a public data channel.

By retrieving the geometry data directly from the product provider, the product provider retains full control over the delivery of this geometry data or sensitive data within this geometry data and prevents these data from being processed by the intermediary's backend and relieves the intermediary from having to forward it to the supplier.

The intermediary 10 presents structural data of the product, parts of the product, components, or sub-components of the product to the supplier for the purpose of sampling. The supplier has the option of requesting graphic drawings for the respective parts, components, and sub-components.

The initial step of such a query is the authentication of the supplier against the supplier directory of the product provider 14. The intermediary 10 receives an access token as a result of successful authentication.

The intermediary 10 now makes a general access request (general release) to the product provider 14 via the privileged channel 16 (control flow). This request is made using the access token obtained during authentication.

The product provider 14 checks the access token for validity and authorizes the call. After successful authorization, the product provider 14 prepares available graphical data of the requested product, part, component, or sub-component and makes it available for later access by the supplier 12.

The intermediary 10 then uses the structural data of the product, parts, components, or sub-components received from the product provider 14 via a separate interface to determine the geometries and request these from the product provider 14 via the privileged channel 16 (URL request). As a result of this request, the intermediary 10 receives protected Internet addresses, which he forwards to the supplier 12 via channel 18.

The supplier 12 now calls the protected Internet addresses received from the product provider 14 via channel 20 (data flow) and receives encrypted graphical binary data (geometry data). The geometry data is merged with the existing structural data at the supplier 12. At the supplier 12, the graphic drawing of the part, product, components, or sub-components of the product is now integrated into the opened part display of supplier 12.

According to the disclosure, the intermediary 10 thus provides the product provider 14 with a software component. The geometry data is merged with the structural data previously received from the intermediary 10 only at the supplier 12.

The method according to the disclosure is specifically designed for use in the automotive industry for e.g. a car manufacturer as the provider and a first tier as a supplier for e.g. a part or a component for the car of the car manufacturer or for e.g. a first tier of a car manufacturer with the supplier being a supplier for the first tier.

### Advantageous Features of the Disclosed Process

### Data Snippets

In order to minimize the impact of a possible attack on the computer systems of the product provider 14 (data owner), the product provider 14 stores the layers of a graphical representation separately and without information on their structural composition.

### Conversion of Graphic Files

The computer system includes functions for converting raw graphic data into a standard binary format (geometric data), which can be displayed in the user interface of the intermediary 10.

### Data Filling

The intermediary 10 requests components from the product provider 14 in a separate channel (channel 16). In response to a successful authorization of this request, systems of the product provider 14 collect relevant files and transfer them via an internal interface within the computer system of the product provider 14 for the subsequent request by the supplier 12.

These files are processed by the product provider 14 to generate both binary graphic files and component structure information in a standardized format.

Binary graphic files are stored in encrypted form in a private data storage (long-term storage) at the product provider 14 and form the basis for subsequent protected publications by transmission (in encrypted form) to the supplier 12 following its request to the product provider 14.

Component structure information (structure data) is not stored as protected data by the product provider 14, but is instead transferred to the intermediary 10 via a separate data interface (on special access).

### External User Directories

The intermediary 10 integrates the supplier directory of the product provider 14 in order to be able to make calls on behalf of the supplier 12 via the channel 16.

### Supplier Numbers

The suppliers 12 register supplier numbers of the product supplier 14 with the intermediary 10. Calls at the product provider 14 are allocated these numbers and are used by the provider as part of the authorization process.

### General Release

Before Internet addresses can be retrieved from the supplier 12 by the intermediary 10, a general authorization check (general release) is needed for the component.

General releases are requested via channel 16 (control flow) and lead to the preparation of corresponding files for the purpose of delivery (staging) by the product provider 14.

### Delegation

After successful general release, the authorized supplier 12 has the option of delegating authorizations obtained for selected subcomponents to the next lower supplier in the supply chain of the respective component.

Delegations are requested via the channel 16. Corresponding data records are stored at the product provider 14 in chained form (trust chain).

### End-to-End Encryption

The product provider 14 supports end-to-end encryption of the delivered geometry files. The key material needed for this is exchanged via channels 18, 16 (control flow). The delivery of the encrypted data is realized via the separate data channel 20 (data flow) (indicated in the drawing by “gITF data”).

### Glossary

Provider: Data owner, partner of the intermediary; provides sensitive graphic data via the mechanism described.

Intermediary backend: Intermediaries, computer systems of the Internet platform, which are operated under the sovereignty of material.one.

System components provided: Libraries, docker containers, SaaS

Provider application: Runtime component which is operated under the sovereignty of the provider (data owner).

Geometry data: Data that is managed and delivered by the provider and is only merged with the structural data for the supplier to form the design data on the basis of which the supplier can, for example, submit a quotation for the manufacture/supply of the product, parts, components or sub-components of the product.

Access code: An Internet address that contains authorization information in addition to the identification of a resource.

Control flow: Privileged access to the provider, which is used exclusively by the intermediary.

Data flow: Publicly accessible endpoint for retrieving graphics via protected Internet addresses (key URL).

Staging: Transfer of requested files to a temporary data memory optimized for access.

Trust chain: Concatenation of information about cryptographic operations for the purpose of integrity preservation.

### LIST OF REFERENCE NUMERALS

10 intermediaries with Internet platform
12 suppliers
14 product provider
16 transmission channel
18 transmission channel
20 transmission channel

What is claimed is:

1. A computer-implemented method for automatically providing access to construction data of a product of a provider and/or of parts and/or components of a product of a provider to a potential supplier manufacturing or procuring the product for the provider for purpose of transmitting the construction data via a data link between a computer system of the provider and a computer system of the supplier, comprising:
dividing the construction data in the computer system of the provider into at least two sets of data, including structural data representative of, inter alia, a general structure of the product and/or of at least one of its parts and/or of at least one of its components and, if applicable, at least one of its sub-components, and geometry data representative of, inter alia, a geometric arrangement and geometry and dimensions of the product and/or of at least one of its parts and/or of at least one of its components and/or, if applicable, at least one of its sub-components, with knowledge of the at least two sets of data being requested for the manufacture and/or for the procurement of the product and/or of at least one of its parts and/or of at least one of its components and/or, if applicable, at least one of its sub-components;
providing a platform on Internet by a computer system of an intermediary, via which a supplier previously registered on the platform can download the structural data using a computer system of the supplier;
making the geometry data only available via the computer system of the provider;
transmitting the geometry data to the computer system of the supplier, wherein the transmitting of the geometry data is exclusively enabled via the computer system of the provider;
providing access, by the computer system of the intermediary, to the geometry data from the computer system of the provider for the supplier via the Internet upon a request from the computer system of the supplier via the Internet;
transmitting the geometry data, upon providing access, from the computer system of the provider to the computer system of the supplier;
generating, by the computer system of the provider, an access code for access to the geometry data by the computer system of the supplier;
transmitting the generated access code to the computer system of the intermediary via the Internet;
forwarding, by the computer system of the intermediary, the access code to the computer system of the supplier via Internet; and
retrieving and/or downloading, from the computer system of the provider, the geometry data of the product and/or of at least one of its parts and/or of at least one of its components or, if applicable, of at least one of its sub-components via the data link between the computer system of the provider and the computer system of the supplier, wherein retrieving and/or downloading is performed by the computer system of the supplier.

2. The method according to claim 1, wherein geometry data is data determined by the provider to be more confidential than construction data.

3. The method according to claim 1, wherein the supplier registered in the computer system of the intermediary has been previously authorized by the computer system of the provider vis-à-vis the computer system of the intermediary.

4. The method according to claim 3, wherein the retrievability of the geometry data from the computer system of the provider by the computer system of the supplier is limited in time after receipt of the access code.

5. The method according to claim 1, wherein a graphical representation of the product and/or of at least one of its parts and/or of at least one of its components and possibly of at least one of its sub-components is available to the supplier by downloading the structural data from an internet platform of the intermediary.

6. The method according to claim 1, wherein the Internet is used for the data link between the computer system of the provider and the computer system of the supplier.

7. The method according to claim 1, wherein the geometry data is transmitted in encrypted form via the data link between the computer system of the provider and the computer system of the supplier.

8. The method according to claim 7, wherein the provider is a car manufacturer and the supplier is a first tier for a part or a component of the car of the car manufacturer or a first tier for a car manufacturer with the supplier being a supplier for the first tier.
